(19) United States
(12) Patent Application Publication
(10) Pub. No.: US 2003/0073344 A1
(43) Pub. Date: Apr. 17, 2003

(54) Engaging mechanism for IEEE-1394 connector

(75) Inventor: Shan-Yen Yang, Taoyuan City (TW)

Correspondence Address: Richard P. Berg, Esq., c/o LADAS & PARRY, Suite 2100, 5670 Wilshire Boulevard, Los Angeles, CA, 90036-5679, US

(73) Assignee: BENQ Corporation

(21) Appl. No.: 10/190,186

(22) Filed: Jul. 5, 2002

(30) Foreign Application Priority Data
Oct. 12, 2001 (TW) 90217447

(51) Int. Cl. H01R 12/24

(52) U.S. Cl. 439/495

(57) ABSTRACT

An engaging mechanism for IEEE-1394 connector. The connector includes a housing, a shaft fixed to the housing and a resilient piece rotatably connected to the shaft. The resilient piece includes an engaging portion formed at one end, an action portion formed at the other end, and a resilient arm extending between the ends and against the housing.

### BACKGROUND OF THE INVENTION

1. Field of the Invention

The present invention relates in general to an engaging mechanism for an IEEE-1394 connector.

2. Description of the Related Art

“IEEE-1394” is commonly developed by several big companies including IBM, TI, Sony and Philips, for integrating computers, consumption electric products and communication devices via an interface.

The conventional engaging mechanism of an IEEE-1394 connector has a shaft, which is not maintained at a fixed position during operation so that a correct operation of the engaging mechanism necessarily depends on user's manual control. The related patents include U.S. Pat. No. 5,588, 864, U.S. Pat. No. 5,178,556 etc.

### SUMMARY OF THE INVENTION

An object of the present invention is to provide a connector that solves the above-mentioned problem.

The connector of the present invention includes a housing, a shaft fixed to the housing and a resilient piece rotatably connected to the shaft. The resilient piece includes an engaging portion formed at one end, an action portion formed at the other end, and a resilient arm extending between the ends and against the housing.

In operation, the shaft is not movable. This ensures a correct motion of the engaging mechanism and solves the conventional problem.

### BRIEF DESCRIPTION OF THE DRAWINGS

The present invention can be more fully understood by reading the subsequent detailed description and examples with references made to the accompanying drawings, wherein:

FIG. 1 is an exploded perspective diagram of an IEEE-1394 connector in accordance with the present invention;

FIG. 2 is a perspective diagram of a resilient piece in accordance with the present invention;

FIG. 3 is a local view of the IEEE-1394 connector of the present invention;

FIG. 4 depicts an operation of the IEEE-1394 connector of the present invention; and

FIG. 5 depicts an equivalent mechanism for analyzing the engaging mechanism of the IEEE-1394 connector of the present invention.

### DETAILED DESCRIPTION OF THE PREFERRED EMBODIMENT

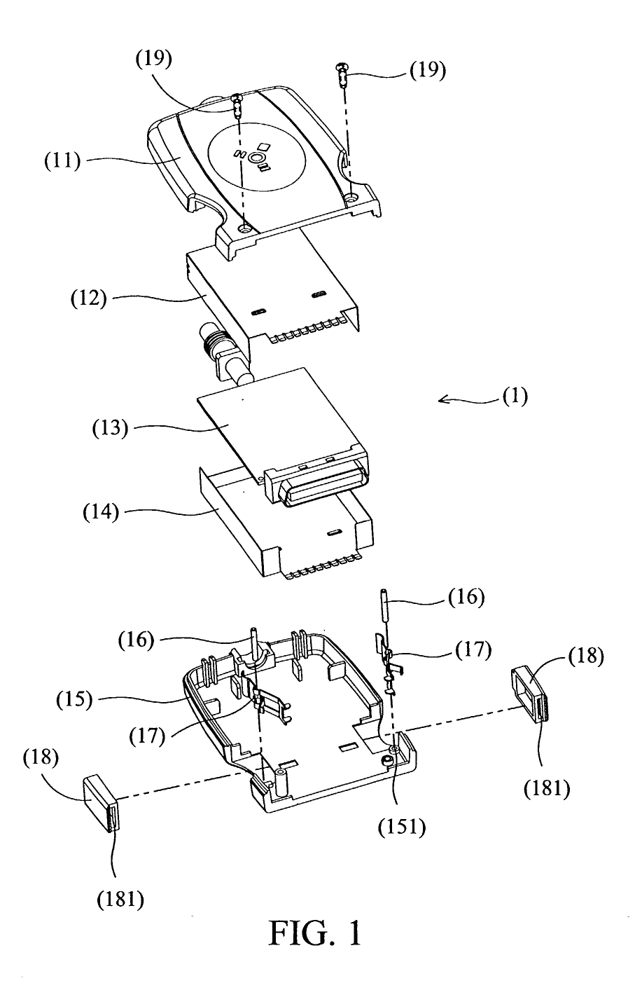

FIG. 1 is an exploded perspective diagram of an IEEE-1394 connector of the present invention, in which a printed circuit board (13) is housed by two metal brackets (12, 14). The metal brackets (12, 14) are used for preventing electromagnetic wave from leaking out. Two plastic housings (11, 15) are fixed together by screws (19) to contain other parts of the IEEE-1394 connector.

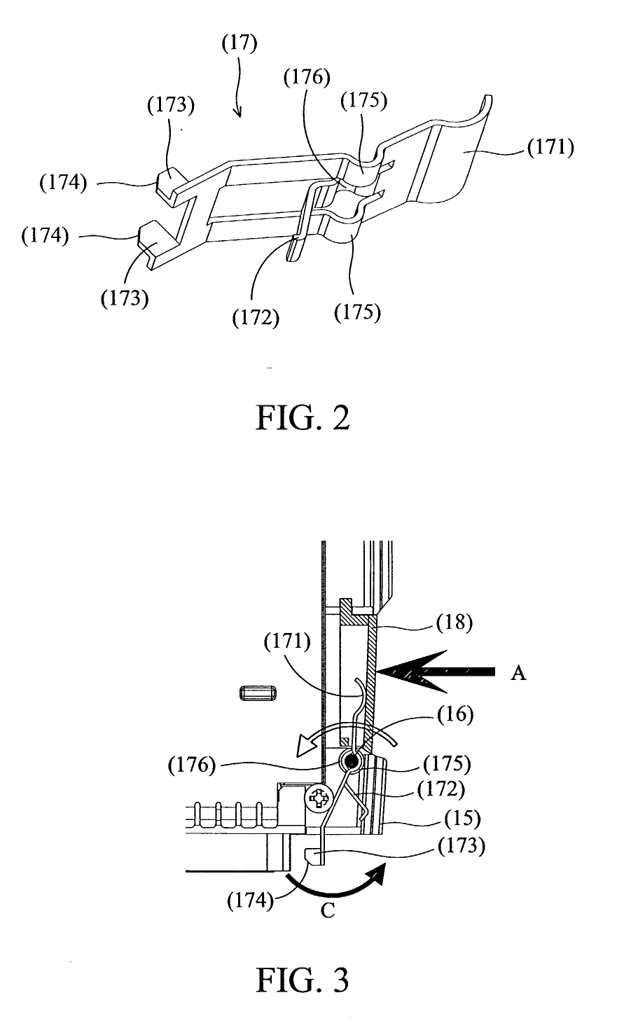

Referring to FIG. 2, a resilient piece (17) has an action portion (171) at one end, a pair of engaging portions (173) at the other end, and a resilient arm (172) formed at the middle by punching. The engaging portions (173) have inclined surfaces (174). The resilient arm (172) has a curved portion (176) while the resilient piece (17) further has two curved portions (175) corresponding to the curved portion (176) of the resilient arm (172). The curved portions (175) and the curved portion (176) are curved in opposite directions, functioning as a ringed portion and allowing a pin (16) to pass therebetween.

Referring to FIGS. 1, 2 and 3, the action portion (171) of the resilient piece (17) is inserted into a hollow key (18) through a hole (181). A pin (16) is inserted through the curved portions (175, 176) of the resilient piece (17) into a hole (151) of the plastic housing (15).

The IEEE-1394 connector of the present invention is operated in accordance with the following manner:

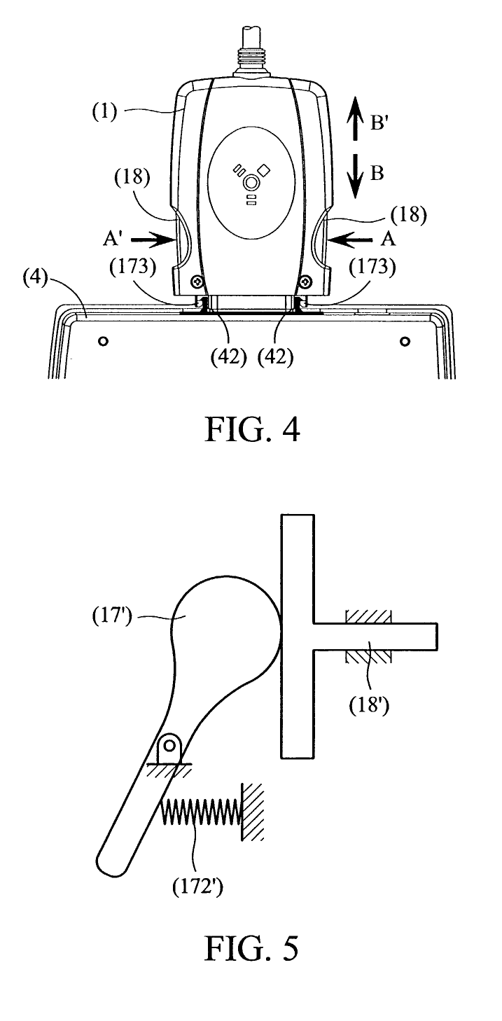

Referring to FIGS. 3 and 4, when detaching the IEEE-1394 connector from an electric device (4), the user presses the keys (18) in directions A, A′. The keys (18) push the action portion (171) of the resilient piece (17) so that the resilient piece (17) is rotated about the pin (16) in direction C. Then, the engaging portions (173) of the resilient piece (17) are disengaged from the engaging portions (42) of the electric device (4) so that the user can pull out the IEEE-1394 connector in direction B′. When the resilient piece (17) is rotated, the resilient arm (172) of the resilient piece pushes against the plastic housing (15) to be deformed. When the user releases the key (18), the resilient piece (17) is restored to the original position via the restoring force of the resilient arm (172).

When connecting the IEEE-1394 connector to the electric device (4), the user directly pushes the IEEE-1394 connector in direction B. The engaging portions (173) of the resilient piece (17) have inclined surfaces, allowing the engaging portions (42) of the electric device (4) to slide to engage the resilient piece (17). The user does not need to press the keys (18).

The degree of freedom of the engaging mechanism of the present invention is 1. In operation, the pin (shaft) is not movable. This ensures a correct motion of the engaging mechanism and solves the conventional problem. The motion analysis of the engaging mechanism of the present invention is as follows:

FIG. 5 depicts an equivalent mechanism for analyzing the engaging mechanism of the present invention, wherein the connecting rod (18′) corresponds to the key (18) of the present invention, the connecting rod (17′) corresponds to the resilient piece (17), and the spring (172′) corresponds to the resilient arm (172). In analysis, a spring is treated as a connecting rod. Therefore, the total number of the connecting rods of the equivalent mechanism is n=3. The connecting rod (18′) and the spring (172′) are operated at 1-degree of freedom. Therefore, the total number of motion of 1-degree of freedom is j₂=2. The connecting rod (17′) is simultaneously movable and rotatable with respect to the connecting rod (18′). Therefore, the total number of motion of 2-degree of freedom is j₂=1. In accordance with the formula of Mechanisms, the degree of freedom of the equivalent mechanism is

$$\begin{matrix}m = 3 ( n - 1 ) - 2 {j}_{1} - {j}_{2} \\ = 3 ( 3 - 1 ) - 2 \cdot 2 - 1 \\ = 1\end{matrix}$$

It is therefore understood that the degree of freedom of the engaging mechanism of the present invention is also 1. This ensures a correct operation of the engaging mechanism of the present invention and solves the conventional problem.

While the invention has been described by way of example and in terms of the preferred embodiment, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A connector for an electric device having a first engaging portion, the connector comprising:
a housing;
a shaft fixed to the housing; and
a resilient piece comprising a second engaging portion formed at one end of the resilient piece, an action portion formed at the other end of the resilient piece, a resilient arm extending between the ends of the resilient piece and against the housing, and a ringed portion formed between the ends of the resilient piece to encircle the shaft so that the resilient piece is rotatably connected to the resilient piece, wherein
the second engaging portion is engaged with the first engaging portion when the connector is connected to the electric device, and the second engaging portion is disengaging from the first engaging portion so that the connector is separated from the electric device when the action portion is pressed to rotate the resilient piece via the shaft.

2. A connector as claimed in claim 1, further comprising a key connected to the action portion of the resilient piece.

3. A connector as claimed in claim 1, wherein the ringed portion comprises a first curved portion and a second curved portion corresponding to the first curved portion, and the first portion and the second portion are curved in opposite directions, with the shaft passing therebetween.

4. A connector comprising:
a housing;
a shaft fixed to the housing; and
a resilient piece rotatably connected to the shaft, the resilient piece comprising an engaging portion formed at one end of the resilient piece, an action portion formed at the other end of the resilient piece, and a resilient arm extending between the ends of the resilient piece and against the housing.

5. A connector as claimed in claim 4, further comprising a key connected to the action portion of the resilient piece.

6. A connector as claimed in claim 4, wherein the resilient arm comprises a first curved portion, the resilient piece further comprises a second curved portion corresponding to the first curved portion, and the first portion and the second portion are curved in opposite directions, with the shaft passing therebetween.
